(19) United States
(12) Patent Application Publication
(10) Pub. No.: US 2013/0257851 A1
(43) Pub. Date: Oct. 3, 2013

(54) PIPELINE WEB-BASED PROCESS FOR 3D ANIMATION

(71) Applicants: Chao-Hua Lee, Taipei City (TW); Yu-Ping Lin, Taipei City (TW); Wei-Kai Liao, Taipei City (TW)

(72) Inventors: Chao-Hua Lee, Taipei City (TW); Yu-Ping Lin, Taipei City (TW); Wei-Kai Liao, Taipei City (TW)

(21) Appl. No.: 13/436,986

(22) Filed: Apr. 1, 2012

(51) Int. Cl. G06T 15/00

(52) U.S. Cl. 345/419

(57) ABSTRACT

An integrated 3D conversion device which utilizes a web-based network includes: a front-end device, for utilizing manual rendering techniques on a first set of data of a video stream received via a user interface of the web-based network to generate depth information, and updating the depth information according to at least a first information received via the user interface; and a server-end device, coupled to the front-end device via the user interface, for receiving the depth information from the front-end device and utilizing the depth information to automatically generate depth information for a second set of data of the video stream, and generating stereo views of the first set of data and the second set of data according to at least a second information received via the user interface.

### BACKGROUND OF THE INVENTION

1. Field of the Invention

The present invention relates to 2D to 3D conversion, and more particularly, to a method of 2D to 3D conversion which uses an integrated web-based process which can be accessed by users worldwide.

2. Description of the Prior Art

Although 3D technology motion pictures have been around since the 1950s, it is only in recent years that the technology has progressed far enough to enable home audio-visual systems to have the capacity for processing and displaying realistic 3D data. 3D televisions and home entertainment systems are now affordable for a large number of people.

The basic principles of 3D imaging are derived from stereoscopic imaging, wherein two slightly offset images (i.e. images from two slightly different perspectives) are generated and presented separately to the left eye and the right eye. These two images are combined by the brain, which results in the image having the illusion of depth. The standard technique for accomplishing this involves the wearing of eyeglasses, wherein the different images can be presented to the left eye and right eye separately according to wavelength (anaglyph glasses), via the use of shutters, or via polarizing filters. Autostereoscopy, which does not require the use of eyeglasses, uses a directional light source for splitting the images between the left and the right eye. All these systems, however, require stereo view (left and right) 3D data.

This recent boom in 3D technology has resulted in many motion pictures, such as Avatar, being both filmed and displayed in 3D. Some movie producers, however, prefer to film pictures in 2D, and then use the techniques of 2D to 3D conversion so that the motion pictures have the option of being viewed in 3D or as originally filmed. This technique can also extend to home audio-visual 3D systems, such that motion pictures or other A/V data originally in a 2D format can be converted into 3D data which can be displayed on a 3D television.

At present, various techniques exist for generating 3D data from 2D inputs. The most common technique is to create what is called a depth map, wherein each pixel in a frame has certain associated depth information. This depth map is a grayscale image with the same dimensions as the original video frame. A more developed version of this technique involves separating a video frame into layers, wherein each layer corresponds to a separate character. Individual depth maps are developed for each layer, which gives a more accurate depth image. Finally, a stereo view is developed from the generated depth maps.

In order to render each frame accurately such that the quality of the final 3D data is guaranteed, not only do individual frames need to be painstakingly divided according to layers, depth, and finite borders between objects and the background, but a 3D artist also needs to ensure that the depth values from one frame to the next progress smoothly. As the aim of 3D technology is to create a more ‘real’ experience for a viewer, inaccuracies between frames (such as the ‘jumping’ of one figure projected in the foreground) will seem more jarring than when being viewed in a traditional 2D environment.

This kind of rendering process therefore requires highly time-consuming human labour. The expenses involved in converting a full-length motion picture are also huge. This has led some manufacturers to develop fully automated 2D to 3D conversion systems, which use algorithms for generating the depth maps. Although these systems offer fast generation of 3D data at low cost, the resultant quality of the data is low. In a competitive market, with ever more sophisticated electronic devices, consumers are unwilling to settle for a subpar viewing experience.

### SUMMARY OF THE INVENTION

It is therefore an objective of the present invention to provide an efficient way of generating 3D data for a 2D video stream that can reduce the amount of time and human resources required, while still generating high quality 3D data.

One aspect of the invention is to provide a combined front-end and server-end device that can communicate across a Web-based network, wherein video data is first analyzed by the server-end device for identifying keyframes; depth maps for the keyframes are generated manually by the front-end device; and depth maps for non-keyframes are generated automatically from the keyframe depth maps by the server-end device. The front-end and server-end are able to communicate with each other via http requests.

Another aspect of the invention is that the dedicated front-end device is split into a first front-end device, a second front-end device and a third front-end device, wherein interfaces between all three front-end devices are handled by http requests, such that tasks to be performed by users of the first front-end device can be scheduled by users of the second front-end device, and a feedback mechanism is enabled by users of the third front-end device. Furthermore, the interface between the front-end and the server-end allows users of the second front-end device to assign tasks directly according to server-end information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method for converting 2D inputs into 3D data according to an exemplary embodiment of the present invention.

FIG. 2 is a diagram of the integrated front-end and server devices according to an exemplary embodiment of the present invention.

### DETAILED DESCRIPTION

The present invention advantageously combines both a server-end device for performing automatic processing, and a front-end device for performing manual processing (human labour), wherein the server-end and front-end device can communicate via web-based software, through http requests. In addition, the front-end device is split into three front-end devices which individually interface with the server-end via http requests, for enabling scheduling of different tasks such that a single video frame can be rendered, analyzed, and edited by different 3D artists. This integration of front-end and server devices also allows for a feedback mechanism for both automatic operations and manual operations. In other words, a pipeline procedure is enabled by the combined front-end and server-end devices. The use of the web-based network for communication means that users have the flexibility to work anywhere and at any time, while the complicated algorithms and data can be stored in the server-end.

The following description particularly relates to processing of software in the front-end and server-end devices which are designed by the applicant; however, the invention is directed towards the method of managing the software and therefore the various algorithms referenced herein are not disclosed in detail. It will be appreciated by one skilled in the art that the disclosed method as applied to the server and front-end devices can also be applied to a combined server and front-end device using different algorithms and software as long as said algorithms are for generating stereo 3D content from 2D inputs. Therefore, in the following description, algorithms will be referenced in terms of the particular tasks they are designed for achieving, and certain software components will be referenced by brand name for ease of description but the claimed method can be applied to other software and algorithms that are used for performing similar operations.

As such, in the following, the server-end components are carried out by software called ‘Mighty Bunny’, and front-end components are: ‘Bunny Shop’, which enables 3D artists to create, draw and modify depth maps using Depth Image Based Rendering (DIBR); ‘Bunny Watch’ for project managers to assign work to 3D artists, as well as monitor the 2D to 3D conversion projects and perform quality assessment; and ‘Bunny Effect’, which allows supervisors to adjust the 3D effects and perform post-processing.

The above software components can be implemented in any pre-existing network which supports TCP/IP. Interfaces between the front-end and server are implemented using http requests.

The three main aspects of the invention are to reduce the amount of manual depth map generation required for processing a video stream by combining automatic and manual processing for 3D conversion; to increase the consistency and quality of 3D video data across frames via an automation process; and to increase the efficiency and accuracy of manually generating the depth maps and post-processing by implementing a web-based user interface which enables project managers to separate and assign tasks, and enables supervisors to directly correct errors in generated 3D data. The web-based software allows complete flexibility of performing tasks, as users can be based worldwide.

The first two aspects are achieved via the use of the server-end device for identifying keyframes within a video stream. As detailed in the above, to convert 2D data into 3D data, grayscale images that assign pixel values for representing depth need to be generated for each frame of a video stream. In some frames, the change in depth information between a current frame and a directly preceding frame will be large; for example, when there is a scene change such that there is a large difference between the respective motion vectors in the current frame and the preceding frame. These frames are defined as keyframes, and are identified by the server-end device using feature tracking algorithms. The server-end can further analyze content features and other components for identifying the keyframes. On average, only about 12% of frames of an entire video stream will be keyframes.

The front-end software then employs human 3D artists for manually rendering the keyframes, by generating depth maps for each layer of a video frame and identifying objects. Particular techniques used for rendering the frame are individual to different conversion software. The dedicated software as designed by the applicant will be referenced later. In addition, the 3D artists work can be monitored by project managers who can perform quality assessment over the web-based network by (for example) marking particular areas that are judged as having problems, and leaving comments for the 3D artists. The use of the web-based network means that a 3D artist can quickly receive performance assessments and carry out corrections, no matter where the 3D artist and project manager are located.

Once the depth map has been generated to the 3D artist and project manager' s satisfaction, it will be sent to the server-end device. The server-end device then assigns pixel values to foreground and background objects to generate alpha masks for each keyframe. The server-end device uses these alpha masks as well as tracking algorithms for estimating segmentation, masking and depth information for non-keyframes. The server-end device can then use this estimation for directly (automatically) generating alpha masks for all non-keyframes. As all keyframes have depth maps created through entirely human labour, the quality of these keyframes can be assured. The use of these keyframes for generating depth maps for non-keyframes in combination with the human-based assessment of all data means that a high quality of all frames of the data is guaranteed. In other words, although non-keyframes have automatically generated depth maps, the quality of these depth maps should be as high as those generated for the keyframes by human labour.

The process remains at the server-end, where stereo views for all frames can be generated automatically, by using dedicated mathematical formulae designed to accurately model depth perception as perceived by human eyes. The generated stereo views can then proceed to post-processing, which can be performed both at the server-end and at the front-end. In general, post-processing is for removing artifacts and for filling in holes. These particular aspects will be detailed later.

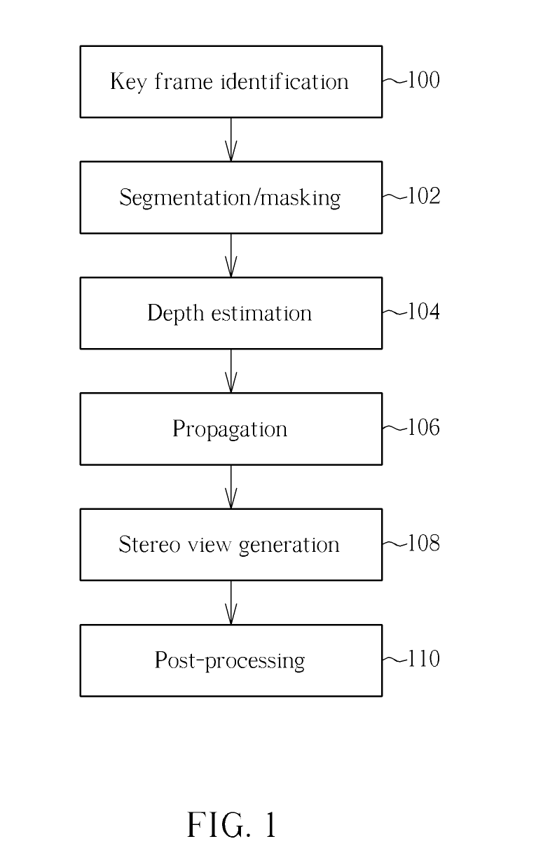

The implementation of the user interface between the front-end and the server-end enables 3D conversion to be carried out in a pipelined manner. The entire 2D to 3D conversion method according to the disclosed invention is illustrated in FIG. 1. The steps of the method are as follows:

Step 100: Keyframe identification

Step 102: Segmentation and masking

Step 104: Depth estimation

Step 106: Propagation

Step 108: Stereo view generation

Step 110: Post-processing

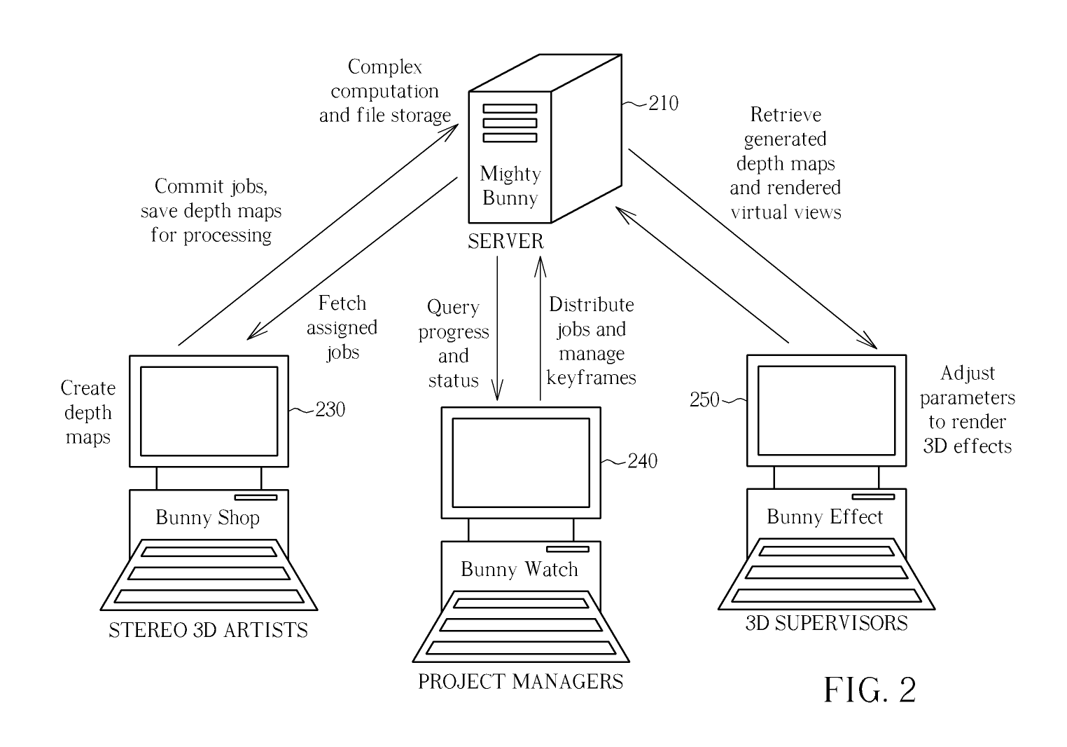

In addition, please refer to FIG. 2, which illustrates the first front-end device, the second front-end device, the third front-end device and the server-end device. Interfaces between front-end and server are enabled by http requests; access may depend on a user identification or job priority. In the following, the various devices are referenced according to the dedicated software they utilize; hence, the first front-end device is known as ‘Bunny Shop’, the second front-end device is known as ‘Bunny Watch’ and the third front-end device is known as ‘Bunny Effect’. The server-end device is known as ‘Mighty Bunny’. After reading the accompanying description, however, it should be obvious to one skilled in the art that different software can be used for achieving the aims of the present invention, by implementing the web-based network pipeline procedure and semi-manual semi-automatic depth map generation technique.

As mentioned above, ‘Mighty Bunny’ as the server-side component generates the alpha maps which indicate the coverage of each pixel. Before the image processing is performed by the front-end software, ‘Mighty Bunny’ will analyze all frames of a particular video stream and identify keyframes. A keyframe is one in which there is a large amount of movement or change between a directly preceding frame and the frame in question. For example, the first frame of a new scene would be classified as a keyframe. ‘Mighty Bunny’ further performs image segmentation and masking. For these keyframes, the server-side component utilizes the interface between itself and the front-end software to assign ‘Bunny Shop’ 3D artists to manually process the frame for generating stereo 3D content (i.e. using depth maps to generate trimaps, which will then be sent to the server-side component for alpha mask generation). In the particular software utilized by the applicant, the server will communicate with ‘Bunny Watch’ which is utilized by project managers for assigning 3D artists with particular tasks; however, this is merely one implementation and not a limitation of the invention.

A 3D artist logs into the system via ‘Bunny Shop’ wherein the artist has access to many tools which allow the artist to draw depth values on a depth map, fill a region on a frame with a selected depth value, correct depth according to perspective, generate trimaps (from which an alpha map can be computed at the server side), select regions that should be painted, select or delete layers in a particular frame, and preview the 3D version of a particular frame. A particular task is assigned to the 3D artist via ‘Bunny Watch’, which sends assigned tasks to the server which can then be retrieved by ‘Bunny Shop’. ‘Bunny Watch’ is also for monitoring and commenting on the depth map generated by a 3D artist. The communication between ‘Bunny Watch’ and ‘Bunny Shop’ means that a highly accurate depth map can be generated. The server-side component then assigns pixel values to objects according to the depth map information and generates an alpha mask which fully covers, uncovers, or gives each pixel some transparency according to the pixel values. It should be noted that the web-based integrated server-end and front-end interface means that manual and automatic processing can occur in parallel, which considerably speeds up the conversion process.

Once all keyframes are identified and alpha masks are generated, an assumption can be made that for those frames between keyframes (non-keyframes) the change in depth values between foreground and background objects from frame to frame is not so great. For example, in a sequence where a person is running through a park, the background scenery is largely constant and the distance between the running figure and the background largely remains the same. Therefore, it is not essential to process each non-keyframe using human labour ('Bunny Shop') as depth values for a particular non-keyframe can be automatically determined from depth values of a directly preceding frame. According to this assumption, depth maps for non-keyframes do not need to be individually generated by 3D artists (i.e. by ‘Bunny Shop’) but can instead be automatically generated at the server end (by ‘Mighty Bunny’). According to the generated depth maps, ‘Mighty Bunny’ can then automatically generate alpha masks.

As the number of keyframes for a particular video stream is usually approximately 10% of the total frames, automatically generating depth maps and alpha masks for non-keyframes can save on 90% of the human labour and resources. Using the web-based network so that highly accurate depth maps are generated means that the quality of the non-keyframe depth maps can also be ensured. There are various techniques for identifying a keyframe. The simplest technique is to estimate motion vectors of each pixel; when there is no motion change between a first frame and a second frame then the depth map for the second frame can be directly copied from that of the first frame. All the keyframe identification is performed automatically by ‘Mighty Bunny’.

As mentioned above, ‘Mighty Bunny’ also performs segmentation and masking for dividing a keyframe into layers according to objects within the frame, by assigning pixel values. The front-end devices and the interface between them means that different 3D artists can be assigned different layers of an individual 3D frame by ‘Bunny Watch’. ‘Bunny Effect’ which is operated by a supervisor can then adjust certain parameters to render 3D effects for a frame. It is noted that a ‘layer’ here defines a group of pixels with independent motion from another group of pixels, but the two groups of pixels may have the same depth value; for example, in the above example with a runner jogging through a park, there may be two runners jogging together. Each runner would qualify as a different layer.

The rendered frames are then passed back to ‘Mighty Bunny’ for performing propagation, wherein depth information for non-keyframes is either copied or estimated. Identification is assigned to a particular layer according to its motion vector and depth value. When a layer in a first frame has the same ID in a directly following frame, the pixel values for this layer can be propagated (i.e. carried forward) at the server-side. In other words, this process is totally automatic. This propagation feature has the advantage of adding temporal smoothness so that continuity between frames is preserved.

The use of the interface between all software components as enabled by http requests means that, at any stage of the process, the data can be assessed and analyzed by both project managers and 3D supervisors, and corrections can be performed no matter where a particular 3D artist is located. This further ensures the continuity and quality across the frames. The flexibility of the web-based interface allows for both pipeline and parallel processing of tasks, for speeding up the conversion process.

The stereo view generation can proceed automatically via ‘Mighty Bunny’. As is well-known, 3D data is generated by generating a ‘left’ view according to an original view, and then generating the ‘right’ view from the ‘left’ view. The depth information is used to synthesize the ‘right’ view. Where there is no information, however, there will be ‘holes’ at boundaries of objects. ‘Mighty Bunny’ can automatically access the information of neighbouring pixels and use this information to fill in the holes. As above, the server can then send the filled-in image back to the front-end ('Bunny Shop' or ‘Bunny Effect’) where it can be analyzed by a 3D artist or by a supervisor. The interfaces between all software components allow particular flexibility in terms of the order of operations.

In particular, the balance between front-end components and server-side software means that all automatic processes and human labour can be pipelined; the majority of processing is automatic (i.e. server end) but human checking can be employed at every stage, even for post-processing. This is important as, for certain effects, the generated 3D information may be ‘tweaked’ in order to emphasize certain aspects. The use of human labour to process the keyframes, and then automatically generating non-keyframe data according to the keyframes means that an intended vision as to the appearance of the video can be preserved. The particular algorithms used for the 3D conversion include depth propagation, depth map enhancement, vertical view synthesis and image/video imprinting.

In summary, the present invention provides a fully integrated server-end and front-end device for automatically separating a video stream into a first set of data and a second set of data, performing human 3D rendering techniques on the first set of data for generating depth information, utilizing the generated depth information to automatically generate depth information for the second set of data, and automatically generating stereo views of the first set of data and the second set of data. All communication between server-end and front-end devices occurs over a web-based interface, which allows for pipeline and parallel processing of manual and automatic operations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated 3D conversion device utilizing a web-based network,
the integrated 3D conversion device comprising:
a front-end device, for utilizing manual rendering techniques on a first set of data of a video stream received via a user interface of the web-based network to generate depth information, and for updating the depth information according to at least a first information received via the user interface; and
a server-end device, coupled to the front-end device via the user interface, for receiving the depth information from the front-end device and utilizing the depth information to automatically generate depth information for a second set of data of the video stream, and for generating stereo views of the first set of data and the second set of data according to at least a second information received via the user interface.

2. The integrated 3D conversion device of claim 1, wherein the server-end device and the front-end device communicate across the user interface by using http requests.

3. The integrated 3D conversion device of claim 1, wherein the front-end device comprises:
a first front-end device for utilizing the manual rendering techniques to generate depth information and sending the depth information to the server-end device;
a second front-end device for generating the first information to the front-end device to assign tasks to the first front-end device and for monitoring the performance of the manual rendering techniques; and
a third front-end device for generating the second information to the server-end device to adjust parameters of the first set of data and second set of data to render 3D effects, and performing post-processing on the stereo views.

4. The integrated 3D conversion device of claim 3, wherein all tasks performed by the first front-end device, the second-front end device and the third front-end device are assigned via the server-end device.

5. The integrated 3D conversion device of claim 1, being implemented in a network that supports TCP/IP.

6. The integrated 3D conversion device of claim 1, wherein the server-end device analyzes the video stream utilizing at least a tracking algorithm to separate the video stream into the first set of data and the second set of data.
